(19) United States
(12) Patent Application Publication
(10) Pub. No.: US 2016/0049063 A1
(43) Pub. Date: Feb. 18, 2016

(54) Mobility Device Alert

(71) Applicant: Pauline Dennis, Oviedo, FL (US)

(72) Inventor: Pauline Dennis, Oviedo, FL (US)

(21) Appl. No.: 14/820,754

(22) Filed: Aug. 7, 2015

Related U.S. Application Data
(60) Provisional application No. 62/037,342, filed on Aug. 14, 2014.

(51) Int. Cl. G08B 21/04; H04W 76/00

(52) U.S. Cl. CPC G08B 21/0446; H04W 76/007

(57) ABSTRACT

A mobility device alert is provided. The mobility device alert includes a mobility device having a housing attached thereon. The mobility device includes a walker and a wheelchair having a set of wheels mounted thereon. The housing is attached by the wheels of the mobility device and is configured to receive an alert assembly therein. The alert assembly is configured to detect at least one rotation of the wheels and trigger an alert that notifies a caretaker that a user of the mobility device alert may require immediate assistance or may be in immediate danger. The alert assembly also includes a transmitter that sends a wireless alert signal to a corresponding receiver that can be held by the caretaker to notify the caretaker of a possible emergency situation.

### CROSS REFERENCE TO RELATED APPLICATION

This application claims the benefit of U.S. Provisional Application No. 62/037,342 filed on Aug. 14, 2014. The above identified patent application is herein incorporated by reference in its entirety to provide continuity of disclosure.

### BACKGROUND OF THE INVENTION

### Field of the Invention

The present invention relates to tools for disabled or the elderly who need additional support to maintain balance or stability. More specifically, the present invention pertains to an improved mobility device alert that allows a caretaker to keep track of a user using a mobility device, such as a wheelchair or a walker.

People who are afflicted with Alzheimer's disease and other kinds of dementia exhibit wandering behavior. It can happen on foot, driving, or in a wheelchair. These wandering episodes sometimes can lead to happy and amusing endings, however, many times these types of wandering episodes may lead to serious injury or death. There can be many reasons that can cause people afflicted with Alzheimer's disease and other kinds of dementia to start wandering. One of these causes includes confusion and disorientation about their location even in their own home or community, which initiates the wandering. Another one of these causes is discomfort and the desire of going home. Sometimes people afflicted with dementia have been residing in the same house for decades, and may not be use to the hospital, senior citizen residence, or other living quarters they are currently living in. Therefore, those people afflicted with dementia are then considered a flight risk as they can be very determined to leave.

There are often guidelines and protocols to follow to care for and monitor a person afflicted with dementia, which may cause wandering. One such guideline is for supervision where one afflicted with a serious wandering problem may require constant supervision, while compared to one having only occasional bouts of confusion who may require less supervision but still need monitoring. However, it is very difficult and burdensome to constantly have a watchful eye for a person afflicted with dementia. Therefore, there is a need for a device that provides for more effective monitoring of one afflicted with Alzheimer's disease or other types of dementia.

The present invention provides a mobility device alert comprising a mobility device, such as a walker or a wheelchair, and a housing attached thereon. The housing is configured to receive an alert assembly therein, which is configured to detect at least one rotation of the wheels of the mobility device. The detection of at least one rotation triggers an audible alert that allows a caretaker to be notified that the user may require immediate assistance or may be in danger. The alert assembly also further includes a transmitter, which sends a wireless alert signal to an appropriate receiver that is held by the caretaker.

### SUMMARY OF THE INVENTION

In view of the foregoing disadvantages inherent in the known types of mobility device alert now present in the prior art, the present invention provides a new and improved mobility device alert wherein the same can be utilized for alerting a caretaker that a user may require immediate assistance.

It is therefore an object of the invention to provide a new and improved mobility device alert that has all of the advantages of the prior art and none of the disadvantages.

Another object of the present invention is to provide a new and improved mobility device alert that includes a mobility device that includes a housing having at least one surface forming an interior volume configured to receive an alert assembly.

Yet another object of the present invention is to provide a new and improved mobility device alert, wherein said mobility device includes a walker and a wheelchair.

Still yet another object of the present invention is to provide a new and improved mobility device alert, wherein said alert assembly is configured to detect at least one rotation of wheels attached on the mobility device and trigger an alert that notifies a caretaker that a user may require assistance.

A further object of the present invention is to provide a new and improved mobility device alert, wherein said alert assembly comprises a sensor, a microprocessor, a digital storage medium, and a speaker system.

Yet a further object of the present invention is to provide a new and improved mobility device alert, wherein said speaker system includes a digital-to-analog converter, an amplifier and a speaker.

Still yet another object of the present invention is to provide a new and improved mobility device alert, wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a side perspective of the preferred embodiment of the present invention.

FIG. 2 shows a side perspective of a second preferred embodiment of the present invention.

FIG. 3 shows a schematic diagram of an alert assembly of the present invention.

### DETAILED DESCRIPTION OF THE INVENTION

References are made herein to the attached drawings. Like reference numerals are used throughout the drawings to depict like or similar elements of the mobility device alert. For the purposes of presenting a brief and clear description of the present invention, the preferred embodiment will be discussed as used to alert a caretaker of a user who may require their assistance or is a flight risk. The figures are intended for representative purposes only and should not be considered to be limiting in any respect.

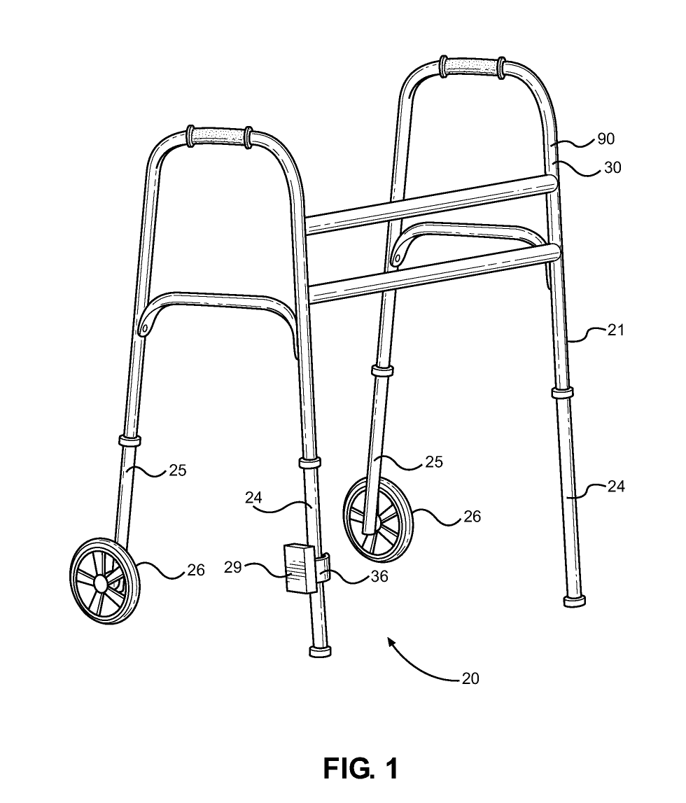

Referring now to FIG. 1, there is shown a side perspective of the mobility device alert 20. The mobility device alert 20 comprises a mobility device 90 configured to aid a user in maneuvering around. In the illustrated embodiment, the mobility device 90 comprises a walker 30 having a wheeled frame 21 comprising a pair of front legs 24 and a pair of rear legs 25. Each of said pair of rear legs 25 comprise a wheel 26 mounted thereon. The front legs 24 are configured to be placed in contact with the floor to aid a user in maneuvering around. In some preferred embodiments, the front legs 24 and the rear legs 25 all include wheels 26 mounted thereon. It is contemplated that preferred embodiments of the mobility device alert 20 depend on the strength and abilities of a user using the mobility device alert 20; therefore, preferred embodiments of the mobility device alert 20 may include a set of wheels 26 attached only to the rear legs 25, or a set of wheels 26 attached to both the front legs 24 and the rear legs 25.

One of the rear legs 25 further includes a housing 29 attached thereon by a fastener 36. The housing 29 includes at least one surface forming an interior volume configured to receive an alert assembly therein. The alert assembly is configured to detect at least one rotation of the wheels attached thereon and subsequently alert a caretaker that the user of the wheeled frame 21 is on the move. In this way, the alert assembly is particularly advantageous as it signals to the caretaker that the user (or patient) may require assistance or is a flight risk, which allows the caretaker to provide more effective care and monitoring. The fastener 36, preferably, is a C-shaped clamp that fastens thereon, however, other types of appropriate fasteners such as hook and loop fasteners are suitable.

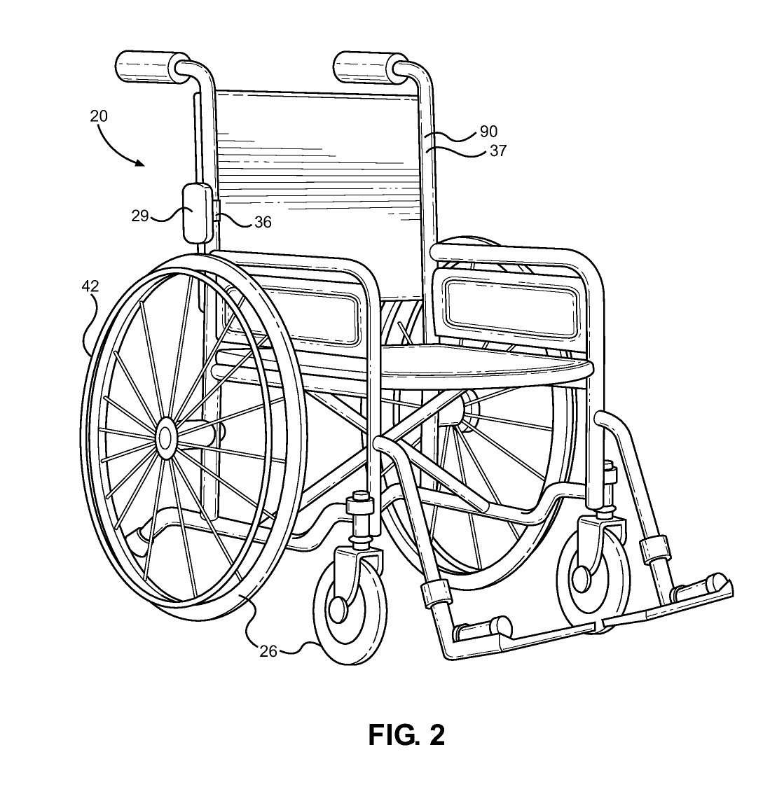

Referring now to FIG. 2, there is shown a side perspective of a second preferred embodiment of the mobility device alert 20. The mobility device alert 20 includes the mobility device 90 comprising a wheelchair 37. The wheelchair 37 includes a seated frame 38 having at least a pair of wheels 26 attached thereon. Preferably, the seated frame 38 includes four wheels 26, wherein the pair of wheels 26 towards a front portion of the seated frame 38 are caster wheels and a second pair of larger wheels 26 in a back portion of the seated frame 38. In some embodiments, it is contemplated that the pair of larger wheels 26 along the back portion 46 include hand rims 42 that allow for a user to self-propel his movement. It is also contemplated that the wheelchair 37 also include embodiments that are electrically propelled by motors along with the manually propelled embodiments, like the one illustrated.

In the illustrated embodiment, one of the rear wheels 26 further includes the housing 29 attached thereon by a fastener 36 and is configured to receive the alert assembly therein. The alert assembly is configured to detect at least one rotation of the wheels 40 of the wheelchair 37 and alert a caretaker that the user of the wheelchair 37 is on the move, thereby allowing the caretaker to better monitor the user. It is contemplated that the fastener 36 is preferably a C-shaped clamp that fastens thereon, however, other types of appropriate fasteners such as hook and loop fasteners are suitable. In other embodiments, the housing 29 is attached on other parts of the wheelchair 37 that allow for the alert assembly to detect rotation of the wheels 40 of the wheelchair 37 to trigger an alert.

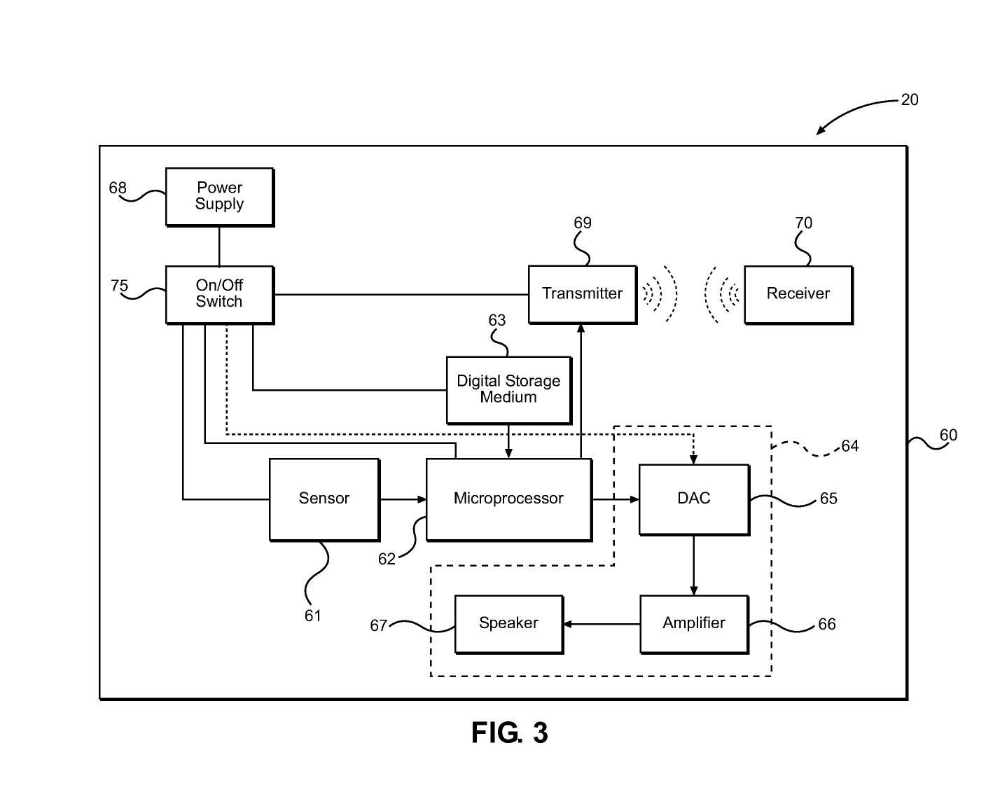

Referring now to FIG. 3, there is shown a schematic diagram of the alert assembly 60 of the mobility device alert 20. The rotation of the wheels of the walker aid triggers the alert assembly 60 stored in the housing fastened to the mobility device. The alert assembly 60 includes an on/off switch 75, a sensor 61, a microprocessor 62, a digital storage medium 63, and a speaker system 64. The speaker system 64 comprises a digital-to-analog converter (DAC) 65, an amplifier 66, and a speaker 67.

The on/off switch 75 is activated to communicate electrical power to the sensor 61, the microprocessor 62, the digital storage medium 63, and the speaker system 64. Preferably, the on/off switch 75 is preferably a rocker switch, however other suitable switches such as a toggle switch are also appropriate. The sensor 61 is configured to detect at least one rotation of the wheels mounted on the mobility device, wherein the rotation triggers the sensor 61 to transmit an output digital signal to the microprocessor 62.

Preferably, the sensor 61 is a Hall Effect sensor, which is particularly commonly used to time the speed and movement of wheels, wherein a magnet is attached to one of the wheels, the sensor 61 detects the completion of at least one revolution. However, other embodiments are alternatively composed of other suitable sensors 61. It is also contemplated that the sensor 61 can also be conditioned to detect several revolutions or the consistent rotation of the wheels for a specified period of time before transmitting an output digital signal to the microprocessor 62. In this way, the sensor 61 does not trigger an alert for accidental rotation and only triggers an alert for prolonged activity. Furthermore, the transmission of an output digital signal can also be cancelled, when the sensor 61 does not detect the rotation of the wheels for a specified period of time. Preferably, the output digital signal is cancelled when the on/off switch 75 is turned off by a caretaker upon reaching the user.

The microprocessor 62 is coupled with a digital storage medium 63, wherein the microprocessor 62 is configured to retrieve a digital alert file and transmit the digital alert file to the speaker system 64. In addition, the alert assembly 60 comprises a power source 68 that is electrically coupled to the sensor 61, the microprocessor 62, the digital storage medium 63, and the speaker system 64. Preferably, the power source 68 is a battery, such as alkaline batteries or rechargeable batteries, however, other embodiments may be alternatively composed of other types of suitable power.

The digital alert file transmitted from the microprocessor 62 is converted into an analog signal by the DAC 65. The analog signal is then amplified by the amplifier 66 and the digital alert file, which is now in an analog signal form, is played through the speaker 67. Preferably, the digital alert file includes an alert that notifies a nearby caretaker that a user may require assistance. The digital storage medium 63 is preferably Random Access Memory (RAM), or a hard drive, however, other suitable alternatives are used in other embodiments. While the alert assembly 60 described is used for controlling the functionality of the alert assembly, alternatives and equivalents including, but not limited to, other types of controller, software, hardware, and/or firmware may be suitable.

Furthermore, the alert assembly 60 also includes a transmitter 69, which sends a wireless alert signal to an appropriate receiver 70 that can be held by a caretaker. The transmitter 69 is electrically coupled to the microprocessor 62 and the power source 68, wherein the transmitter 69 is prompted to send the wireless alert signal upon receipt of a digital signal from the microprocessor 62. The transmitter 69 may use wireless technology known in the art to connect to a router, modem, or other device to obtain telephonic, internet, or other data transmission access. In this way, when a user is not physically close enough to hear the alert, the caretaker can still be alerted of the possible emergency situation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mobility device alert, comprising:
a mobility device;
a housing having at least one surface forming an interior volume and a fastener;
said fastener configured to removably fasten said housing to said mobility device;
said interior volume configured to support an alert assembly therein;
said alert assembly includes a sensor configured to detect wheel rotation;
wherein said alert assembly can register said sensor to alert a caretaker.

2) The mobility device alert of claim 1, wherein:
said mobility device comprises a walker having a wheeled frame having a pair of front legs and a pair of rear legs;
wherein said pair of rear legs each comprising a wheel mounted thereon;
wherein said housing is attached to one of said pair of rear legs.

3) The mobility device alert of claim 1, wherein:
said mobility device further comprises a wheelchair;
said wheelchair includes a seated frame having at least two said wheels mounted thereon;
wherein said housing is attached on said seated frame.

4) The mobility device alert of claim 1, wherein:
said alert assembly further comprises a microprocessor, a digital storage medium, and a speaker system;
wherein said alert assembly is electrically coupled to a power source;
wherein said microprocessor is electrically coupled to said digital storage medium;
said digital storage medium configured to store a digital alert file used to drive said speaker system;
wherein said digital alert file is configured to alert a caretaker that a user of said mobility device is moving and may require assistance.

5) The mobility device alert of claim 4, wherein said speaker system comprising a digital-to-analog converter, an amplifier, and a speaker.

6) The mobility device alert of claim 4, wherein said alert assembly further comprises an on/off switch.

7) The mobility device alert of claim 6, wherein said sensor is configured to detect at least one rotation of said wheels attached thereon, which triggers a transmission of a digital output signal to said microprocessor and stops said transmission when said on/off switch is turned off.

8) The mobility device alert of said claim 7, wherein:
said microprocessor, upon receipt of said output digital signal from said sensor, retrieves said digital alert file from said digital storage medium and transmits said digital alert file to said speaker system;
wherein said speaker system plays said digital alert file as long as said sensor detects said at least one rotation of said wheels.

9) The mobility device alert of said claim 4, wherein said power source is a battery.

10) The mobility device alert of claim 4, further comprising:
a transmitter, which sends a wireless alert signal to a receiver that can be held by a caretaker;
wherein said transmitter is triggered upon receipt of a digital signal transmitted by said microprocessor.

11) The mobility device alert of claim 1, wherein said sensor includes a Hall Effect sensor.

12) The mobility device alert of claim 6, wherein said on/off switch includes a rocker switch.
